(19) United States
(12) Patent Application Publication
(10) Pub. No.: US 2010/0028661 A1
(43) Pub. Date: Feb. 4, 2010

(54) METHOD FOR THE PRODUCTION OF A MULTILAYER LAMINATE, AND MULTILAYER LAMINATE

(75) Inventors: Arno Holzmueller, Kempten (DE); Detlev Schulz, Dietmannsried (DE)

Correspondence Address: KNOBBE MARTENS OLSON & BEAR LLP, 2040 MAIN STREET, FOURTEENTH FLOOR, IRVINE, CA, 92614, US

(73) Assignee: HUHTAMAKI RONSBERG, ZWEIGNIEDERLASSUNG DER HUHTAMA, Ronsberg/Allgaeu (DE)

(21) Appl. No.: 12/517,192

(22) PCT Filed: Nov. 30, 2007
(86) PCT No.: PCT/EP2007/010437

§ 371 Date: Jun. 25, 2009

(30) Foreign Application Priority Data
Dec. 1, 2006 (DE) 10 2006 056 778.1

(51) Int. Cl. B29C 47/04

(52) U.S. Cl. 428/336; 156/244.13

(57) ABSTRACT

The invention relates to a method for the production of a multilayered laminate, especially for the production of packagings, having at least one or two oriented film(s) (40) and at least one barrier layer (30), the following steps being carried out:
providing two, especially sealable, outer films (40), at least one outer film (40) being an oriented outer film (40), and
extruding in between the two outer films (40) an at least three-ply extrudate having a barrier layer material, the extrudate being in the form of a barrier-containing extruded bonding layer (60), and
   the barrier-containing extruded bonding layer (60) being bounded by two outer plies (10) which are each laminated directly onto the respective outer film (40). The invention relates also to a multilayered laminate produced by this method.

The invention relates to a method for the production of a multilayered laminate in accordance with the preambles of patent claims 1 and 2 and to a multilayered laminate in accordance with the preambles of patent claims 16 and 17.

Multilayered laminates have been known for some time and are used inter alia in the packaging industry sector. An example of one possible field of use is the production of film packagings, such as tubular pouches, round pouches and newer kinds of can-like packaging containers. By the provision of a barrier layer in the laminate it is possible for packaging containers produced therefrom to be matched to the physico-chemical properties of a wide variety of contents, it being possible by means of the barrier layer in the laminate for a migration barrier to be provided or, if desired, for the permeability of the laminate towards substances in the contents or in the environment to be adjusted in accordance with requirements.

Also used in the field of the above-described multilayered laminates are oriented films. Such films are relatively ineffective in respect of a barrier action, so that to achieve a barrier action an additional barrier layer is necessary which has to be adhesively bonded to other layers of the multilayered laminate. The oriented film is usually provided on an outer side of the laminate and is likewise bonded by means of adhesive to further laminate layers which, in turn, may have an afore-mentioned barrier layer. Such laminate structures in accordance with the prior art result in laminates of substantial layer thickness and are associated with numerous disadvantages in respect of materials required, foldability and shapeability as well as in respect of disposal.

The necessity to use an adhesive for attaching an oriented film to a layered composite having a barrier layer in accordance with the prior art also entails numerous disadvantages. For example, the use of the adhesive, as mentioned above, results in a disadvantageously increased layer thickness, the use of the adhesive also having an adverse effect on the flexibility and the physico-chemical properties of the laminate. For example, not only the rigidity and the haptic properties of the laminate but also its printability and shapeability, and not least its visual appearance, are adversely affected by the use of adhesive that is necessary in accordance with the prior art for attaching a film to a laminate.

Furthermore, the adhesive necessary to produce such a laminate renders the production of the laminate more expensive, firstly on account of the additional material required, that is to say, for example, the adhesive, and secondly on account of the need to provide adhesive-conveying containers and lines, the requirement to remove and dispose of solvent vapours and inter alia also on account of the cleaning-up work caused by the use of adhesive. Moreover, the disposal of an adhesive-containing laminate is problematic on account of the greater material heterogeneity caused by the adhesive.

The problem underlying the invention is to provide a method which, while avoiding the disadvantages mentioned above, makes it possible to produce a multilayered laminate having at least one oriented film and at least one barrier layer and also having improved physico-chemical properties in comparison with conventional laminates, which laminate is thin in comparison with the prior art. A further problem of the invention lies in the provision of such a laminate.

That problem is solved by a method according to patent claim 1 or 2 and by a laminate according to patent claim 16 or 17.

In particular, the problem is solved by a method for the production of a multilayered laminate, especially for the production of tube-like packagings, having at least one oriented film and at least one barrier layer, the following steps being carried out:
providing two, especially sealable, outer films, at least one outer film being an oriented outer film,
extruding in between the two outer films an at least three-ply extrudate having a barrier layer material, the extrudate being in the form of a barrier-containing extruded bonding layer,
   the barrier-containing extruded bonding layer being bounded by two outer plies which are each laminated directly onto the respective outer film.

Furthermore, the problem according to the invention is solved by a method for the production of a multilayered laminate, especially for the production of tube-like packagings, having two oriented films and at least one barrier layer, the following steps being carried out:
providing two, especially sealable, oriented outer films, and
extruding in between the two outer films an at least three-ply extrudate having a barrier layer material, the extrudate being in the form of a barrier-containing extruded bonding layer,
   the barrier-containing extruded bonding layer being bounded by two outer plies which are each laminated directly onto the respective outer film.

An important aspect of the invention is that the barrier-containing extruded bonding layer is introduced immediately and directly between two outer films in a one-shot process, that is to say in a one-step co-extrusion process. According to the invention, that takes place by supplying the two outer films from respectively two opposite sides of a roller unit, the extrudate having the barrier layer material, which has been freshly produced by co-extrusion, being fed so that it is introduced between the two outer films and, after passing through the pairs of rollers, is firmly bonded thereto on both sides.

An important core concept of the invention is that the extrudate, in the still-warm state, immediately after its production by co-extrusion at a temperature in the range of from 200° C. to 250° C., is introduced, especially extruded in, between the two outer films so that, especially under the roller pressure and the heat, the two outer films are fitted to and pressed against the extrudate, that is to say the barrier-containing extruded bonding layer, and an immediate firm laminate bond between the respective outer ply of the barrier-containing extruded bonding layer and the respective outer film is ensured.

A further important aspect of the invention is that there is used as outer film firstly an oriented outer film which, furthermore, is in the form of a sealable skin-layer film, which is preferably co-extruded. Accordingly, the outer film consists of at least one core film which is coated on the outside and, if desired, for example for the formation of a lap seal, on both sides with a sealable material, which material preferably corresponds to the material of the outer ply of the barrier-containing extruded bonding layer or is at least sealable thereto.

The oriented outer film can be a monoaxially stretched film or a biaxially stretched film. In accordance with a first embodiment of the invention, the oriented film is arranged only on one side of the barrier-containing extruded bonding layer, while on the other side of the barrier-containing extruded bonding layer there is provided a normal, that is to say non-oriented, outer film. If desired, however, in accordance with a second and preferred embodiment of the invention it is also possible for an oriented film to be arranged as outer film on both sides of the barrier-containing extruded bonding layer. As mentioned above, the outer films have sealing properties or are configured to be sealable on one or on both outer side(s), so that, for example, a tubular body can be formed by means of a fin seal but also by means of a lap seal, by sealing the edges of a blank to one another.

According to the invention, the barrier layer is arranged between two outer plies of the barrier-containing extruded bonding layer, it being possible for an additional adhesion-promoting layer also to be arranged between the barrier layer and the respective outer plies of the barrier-containing extruded bonding layer. Accordingly, the barrier-containing extruded bonding layer is of at least three-ply construction, but preferably of five-ply construction.

It is also possible for the outer ply of the barrier-containing extruded bonding layer to be multilayered, especially two-layered. In accordance with this exemplary embodiment, the barrier-containing extruded bonding layer is of at least seven-ply construction.

Accordingly, in the simplest case the barrier-containing extruded bonding layer has a barrier layer surrounded by two outer plies, it being possible, as mentioned above, for an additional adhesion-promoting layer to be arranged between the barrier layer and an outer ply, resulting in a five-ply barrier-containing extruded bonding layer. Furthermore, in the case of a two-layered outer ply, it would be conceivable to have a seven-ply barrier-containing extruded bonding layer. In each case, however, the barrier-containing extruded bonding layer is constructed symmetrically, there being especially the same number of layers on both sides of the barrier layer in a mirror-image arrangement in respect of the barrier layer.

Moreover, according to the invention the barrier-containing extruded bonding layer is in any case, that is to say irrespective of whether it has three, five, seven or more plies, produced in a one-shot process, that is to say in a one-step co-extrusion process.

The speed at which the two outer films are brought together with the barrier-containing extruded bonding layer is, according to the invention, in the range of 50 m/min and 250 m/min, the pressure applied being in the range of from 4×10⁴ Pa (=0.5 bar) to 4×10⁵ Pa(=4 bar).

By adhering to those parameters, an intimate bond between the two outer films and the barrier-containing extruded bonding layer can be achieved, it being possible to produce a laminate which, in comparison with previously known laminates according to the prior art, exhibits significantly smaller layer thicknesses of the individual laminate plies and accordingly a significantly small thickness of the total laminate. For example, layer thicknesses of known barrier-containing laminates are in the range of from 200 μm to 400 μm, whereas laminates produced in accordance with the invention, having the same or comparable haptic properties, barrier property and rigidity but considerably improved shapeability and burst-pressure resistance as well as visual appearance, such as, for example, transparency, have a layer thickness only in the range of from 100 μm to 200 μm.

By virtue of that significantly smaller layer thickness of the laminates produced in accordance with the invention, it is also possible for the shaping in respect of vessels and containers produced from the laminate according to the invention to be more varied, because the radii to be observed when the laminate is folded can be smaller by virtue of its smaller thickness. Moreover, unattractively thick sealing seams, such as are formed on sealing of laminates in accordance with the prior art, can be made visually more attractive and thin by means of the laminates produced in accordance with the invention. This is shown to very positive effect especially in the production of round or tubular, or tube-like, packagings, because the development of a pear-like cross-sectional shape in a round-tubular packaging, such as occurs when customary thick laminates are used, can be avoided according to the invention. Using the laminate according to the invention it is possible to produce, by sealing the end regions of a film blank to one another, preferably by means of lap-seal sealing, substantially truly round packaging tubes which can be processed further to form packagings.

Further advantages of a thin laminate having a small layer thickness produced in accordance with the invention lie in reduced consumption of raw materials in comparison with the prior art, more favourable logistics and transport costs, environ-mentally friendly disposability, because a thinner laminate has less material, and a longer potential machine running time, because during further processing a roll of laminate comprises more running metres of laminate for the same weight and the same dimensions, so that changes of roll, which result in stoppage of production, need to be carried out less frequently. The same applies likewise to the production of the laminate and its arrangement on a roll, because there is space on the roll for more running metres of the thin laminate.

Depending upon the application in question, as mentioned above the outer ply can accordingly be multilayered and/or made of different materials, which are listed hereinbelow, and this, in each case depending upon the field of application, contributes to particular improved barrier properties and/or durability and processing properties of the laminate.

It should also be mentioned that, in accordance with a further embodiment of the invention, an additional layer can be extruded onto at least one outer film, there coming into consideration, in addition to other coating materials, as mentioned below, for example a coating of polypropylene. At this point, for example, reverse-side printing of the additional layer is also conceivable, it being emphasised that the printability of the laminate produced in accordance with the invention is also and particularly optimised for front-side printing.

The application of an additional layer to the symmetrical laminate from the first one-shot extrusion step can be effected, for example, in a second stage of a tandem extruder.

According to the invention, the layers of the laminate are produced from one or more of the materials mentioned in the table below.

| Layer | Materials | |
|---|---|---|
| Oriented | Polypropylene (PP); polyester, especially polyethylene terephthalate | |
| outer film | (PET); polyamide (PA) and mixtures of the mentioned substances | |
| (40), | | |
| sealable, | | |
| especially | | |
| co-extruded | | |
| Non-oriented | Polyolefins, especially polyethylene (PE), polypropylene (PP); | |
| outer film | modified olefins; co-polymers; terpolymers, ionomers; polyamide | |
| | (PA) or polyacrylonitrile (PAN) and mixtures of the mentioned | |
| | substances | |
| Barrier- | Outer ply | Polyolefins, especially polyethylene (PE), poly- |
| containing | | propylene (PP); modified olefins; copolymers; |
| extruded | | terpolymers; ionomers; ethylene/acrylic acid copolymer |
| bonding layer | | (EAA); ethylene-methacrylic acid (EMA); maleic |
| | | anhydride (MA) and mixtures of the mentioned |
| | | substances |
| | Adhesion- | Ethylene/acrylic acid copolymer (EAA); ethylene- |
| | promoting | methacrylic acid (EMA); maleic anhydride (MA); |
| | layer | modified olefins, especially ionomers; copolymers; |
| | | terpolymers and mixtures of the mentioned substances |
| | Barrier | Ethylene vinyl alcohol copolymer (EVOH); |
| | layer | amorphous and/or aromatic and/or partially aromatic |
| | | polyamide (PA); polyacrylonitrile (PAN); polyethylene |
| | | terephthalate (PET) and mixtures of the mentioned |
| | | substances |

| | |
|---|---|
| Additional | Polyolefins, especially polyethylene (PE), polypropylene (PP); |
| layer | modified olefins; copolymers; terpolymers; ionomers; |
| extruded | ethylene/acrylic acid copolymer (EAA); ethylene-methacrylic acid |
| onto the | (EMA); amorphous and/or aromatic and/or partially aromatic |
| outside | polyamide (PA); polyacrylonitrile (PAN); and mixtures of the |
| | mentioned substances |

It is also possible for the layers of the laminate to be produced by the method according to the invention in a thickness as in Table 1 below, layer thicknesses as listed in Table 2 being preferred according to the invention and resulting in afore-mentioned advantages of thin laminates produced in accordance with the invention.

TABLE 1

| | | Preferred | Especially |
|---|---|---|---|
| | | layer | preferred layer |
| | Layer thickness | thickness | thickness |
| Layer | [μm] | [μm] | [μm] |
| Oriented outer film | 3-150 | 5-100 | 10-60 |
| Non-oriented outer film | 3-300 | 5-250 | 10-200 |
| Barrier-containing extruded | 1.1-300 | 10-200 | 20-100.1 |
| bonding layer | | | |
| Barrier layer | 1-100 | 2-80 | 3-50 |
| Additional layer extruded | 1-300 | 5-250 | 10-200 |
| onto the outside | | | |
| Total layer thickness of the | 10-1500 | 25-1000 | 50-800 |
| laminate | | | |

TABLE 2

| | | | Especially |
|---|---|---|---|
| | Layer | Preferred layer | preferred layer |
| | thickness | thickness | thickness |
| Layer | [μm] | [μm] | [μm] |
| Oriented outer film | 10-70 | 20-60 | 30-50 |
| Non-oriented outer film | 20-150 | 40-90 | 50-80 |
| Extruded bonding layer | 25-100 | 35-80 | 50-70 |
| Barrier layer | 2-60 | 2-40 | 5-25 |
| Additional layer on the | 5-100 | 5-60 | 10-40 |
| outside | | | |
| Total layer thickness | 100-250 | 120-200 | 140-180 |
| of the laminate | | | |

Furthermore, the problem according to the invention is solved by a multilayered laminate having at least one oriented film and at least one barrier layer, there being arranged between two, especially sealable, outer films an extrudate having a barrier layer material, the extrudate being in the form of a barrier-containing extruded bonding layer, which is bounded by two outer plies which have each been laminated directly onto the respective outer film in a one-shot process, at least one outer film being an oriented outer film.

Moreover, the problem according to the invention is solved by a multilayered laminate having two oriented sealable outer films and at least one barrier layer, there having been arranged between the outer films in a one-shot process an extrudate having a barrier layer material, the extrudate being in the form of a barrier-containing extruded bonding layer, which is bounded by two outer plies which have each been laminated directly onto the respective outer film.

Further embodiments of the invention will be found in the subsidiary claims.

The invention is described below on the basis of an exemplary embodiment which is described in detail with reference to the FIGURE:

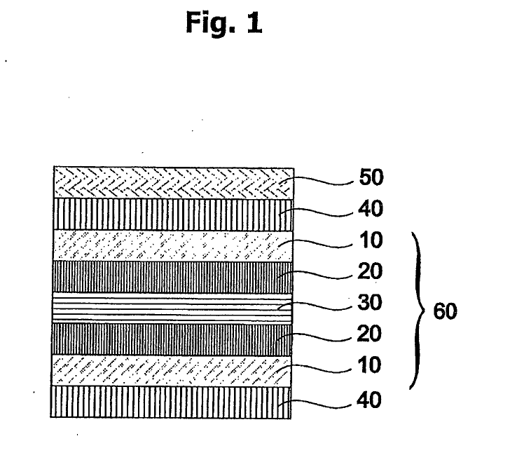

FIG. 1 is a diagrammatic view of a laminate structure according to the invention.

In the description which follows, layers that are the same and have the same action have been given the same reference numerals.

FIG. 1 shows a diagrammatic view of a laminate produced by the method according to the invention, the laminate being composed of a total of eight layers. The barrier-containing extruded bonding layer 60 consists of two respective outer plies which are each joined to a barrier layer 30 by way of an adhesion-promoting layer 20. The five-ply barrier-containing extruded bonding layer 60 so formed has been extruded in between two outer films 40, the respective outer plies 10 being joined immediately and directly, that is to say without the use of adhesive, to the outer film 40. Furthermore, on one side of the laminate (shown at the top in FIG. 1) an additional layer 50 in the form of a polypropylene coating has been applied.

The materials of the laminate according to FIG. 1 have the following composition. The barrier layer 30 surrounded on each side by an adhesion-promoting layer consists of ethylene vinyl alcohol copolymer (EVOH) having a layer thickness of 15 μm. The adhesion-promoting layer joining the outer ply 10 to the barrier layer 30 has a thickness of 10 μm, while the outer ply itself consists of polypropylene having a layer thickness of 13 μm. The outer film laminated onto the respective outer ply 10 consists of bidirectionally stretched oriented polypropylene having a layer thickness of 48 μm. That layer of oriented polypropylene is joined directly to the layer, serving as outer ply, of the barrier-containing extruded bonding layer 60, which is made of polypropylene. Furthermore, the thickness of the additional layer 50 consisting of polypropylene is 33 μm, resulting in a total layer thickness of the laminate of 190 μm.

In accordance with a further embodiment, the outer film 40 of oriented polypropylene has a layer thickness of 50 μm. The barrier-containing extruded bonding layer 60 consists of polypropylene, an adhesion promoter and of EVOH as barrier material with respective layer thicknesses of 12.5 μm for the polypropylene layer, 10 μm for the adhesion promoter layer and 15 μm for the EVOH layer. The second outer film 40 consists of polypropylene and has a layer thickness of 75 μm.

Accordingly, the laminate in accordance with this exemplary embodiment is as follows:

| Material | Layer thickness in μm |
|---|---|
| Oriented polypropylene | 50 |
| Polypropylene | 12.5 |
| Adhesion promoter | 10 |
| EVOH | 15 |
| Adhesion promoter | 10 |
| Polypropylene | 12.5 |
| Polypropylene | 75 |

A laminate in accordance with a further embodiment having two oriented outer films 40 has the following layer structure with the following layer thicknesses:

| Material | Layer thickness in μm |
|---|---|
| Oriented polypropylene | 30 |
| Polyethylene | 12.5 |
| Adhesion promoter | 10 |
| EVOH | 15 |
| Adhesion promoter | 10 |
| Polyethylene | 12.5 |
| Oriented polypropylene | 30 |
| Polyethylene | 40 |

It should be pointed out here that all the above-described parts, considered alone and in any combination, especially the details shown in the drawing, are claimed as being important to the invention. Modifications thereof will be familiar to the person skilled in the art.

### REFERENCE NUMERALS

10 outer ply
20 adhesion-promoting layer
30 barrier layer
40 outer film
50 additional layer
60 barrier-containing extruded bonding layer

1. A method for the production of a multilayered laminate, especially for the production of tube-like packagings, having at least one oriented film and at least one barrier layer, said method comprising the following steps
providing two, especially sealable, outer films, at least one outer film being an oriented outer film, and
extruding in between the two outer films an at least three-ply extrudate having a barrier layer material, the extrudate being in the form of a barrier-containing extruded bonding layer,
the barrier-containing extruded bonding layer being bounded by two outer plies which are each laminated directly onto the respective outer film.

2. A method according to claim 1, for the production of a multilayered laminate, especially for the production of tube-like packagings, having two oriented films and at least one barrier layer, said method comprising the following steps
providing two, especially sealable, oriented outer films, and
extruding in between the two outer films an at least three-ply extrudate having a barrier layer material, the extrudate being in the form of a barrier-containing extruded bonding layer,
the barrier-containing extruded bonding layer being bounded by two outer plies (which are each laminated directly onto the respective outer filmy.

3. A method according to claim 1, wherein the oriented film comprises a monoaxially or biaxially stretched film.

4. A method according to claim 1, wherein the barrier layer is arranged between two outer plies of the barrier-containing extruded bonding layers, especially being co-extruded together with those outer plies.

5. A method according to claim 1, wherein an adhesion-promoting layer is arranged between at least one outer ply and the barrier layer, especially being co-extruded together with those outer plies and the barrier layer.

6. A method according to claim 1, wherein the barrier-containing extruded bonding layer is constructed, especially extruded, symmetrically in respect of the barrier layer.

7. A method according to claim 1, wherein the outer ply is produced with a multilayered, especially two-layered, construction.

8. A method according to claim 1, wherein the barrier-containing extruded bonding layer is co-extruded in a one-shot process and immediately after the co-extrusion is brought together with the outer films and joined thereto by the application of pressure and heat, especially heat present from the extrusion operation.

9. A method according to claim 8, wherein a speed of bringing-together in the range of 50 m/min to 250 m/min is used.

10. A method according to claim 8, wherein the pressure used is in the range of from 5×10⁴ Pa (=0.5 bar) to 4×10⁵ Pa (=4 bar).

11. A method according to claim 1, wherein an additional layer is applied to, especially extruded onto, the outside of at least one outer film.

12. A method according to claim 1, wherein as the oriented outer film there is used a sealable film, especially a co-extruded sealable film.

13. A method according to claim 1, wherein the layers of the laminate are produced from one or more of the following materials:

| Layer | Materials | |
|---|---|---|
| Oriented | Polypropylene (PP); polyester, especially polyethylene | |
| outer film | terephthalate (PET); polyamide (PA) and mixtures of the | |
| (40), | mentioned substances | |
| sealable, | | |
| especially | | |
| co-extruded | | |
| Non- | Polyolefins, especially polyethylene (PE), polypropylene (PP); | |
| oriented | modified olefins; co-polymers; terpolymers, ionomers; polyamide | |
| outer film | (PA) or polyacrylonitrile (PAN) and mixtures of the mentioned | |
| (40) | substances | |
| Barrier- | Outer ply | Polyolefins, especially polyethylene (PE), poly- |
| containing | (10) | propylene (PP); modified olefins; copolymers; |
| extruded | | terpolymers; ionomers; ethylene/acrylic acid |
| bonding layer (60) | | copolymer (EAA); ethylene-methacrylic acid (EMA); |
| | | maleic anhydride (MA) and mixtures of the |
| | | mentioned substances |
| | Adhesion- | Ethylene/acrylic acid copolymer (EAA); ethylene- |
| | promoting | methacrylic acid (EMA); maleic anhydride (MA); |
| | layer (20) | modified olefins, especially ionomers; copolymers; |
| | | terpolymers and mixtures of the mentioned |
| | | substances |
| | Barrier | Ethylene vinyl alcohol copolymer (EVOH); |
| | layer (30) | amorphous and/or aromatic and/or partially aromatic |
| | | polyamide (PA); polyacrylonitrile (PAN); |
| | | polyethylene terephthalate (PET) and mixtures of the |
| | | mentioned substances |
| | |
|---|---|
| Additional | Polyolefins, especially polyethylene (PE), polypropylene (PP); |
| layer on the | modified olefins; copolymers; terpolymers; ionomers; |
| outside (50) | ethylene/acrylic acid copolymer (EAA); ethylene-methacrylic acid |
| | (EMA); amorphous and/or aromatic and/or partially aromatic |
| | polyamide (PA); polyacrylonitrile (PAN); and mixtures of the |
| | mentioned substances |

14. A method according to claim 1, wherein the layers of the laminate are produced in a thickness as follows:

| | | | Especially |
|---|---|---|---|
| | | Preferred layer | preferred layer |
| | Layer thickness | thickness | thickness |
| Layer | [μm] | [μm] | [μm] |
| Oriented outer film | 3-150 | 5-100 | 10-60 |
| (40) | | | |
| Non-oriented outer | 3-300 | 5-250 | 10-200 |
| film (40) | | | |
| Extruded bonding | 1.1-300 | 10-200 | 20-100.1 |
| layer (60) | | | |
| Barrier layer (30) | 1-100 | 2-80 | 3-50 |
| Additional layer on | 1-300 | 5-250 | 10-200 |
| the outside (50) | | | |
| Total layer thickness | 10-1500 | 25-1000 | 50-800 |
| of the laminate | | | |

15. A method according to claim 1, wherein the layers of the laminate are produced in a thickness as follows:

| | | | Especially |
|---|---|---|---|
| | | Preferred layer | preferred layer |
| | Layer thickness | thickness | thickness |
| Layer | [μm] | [μm] | [μm] |
| Oriented outer film | 10-70 | 20-60 | 30-50 |
| (40) | | | |
| Non-oriented outer | 20-150 | 40-90 | 50-80 |
| film (40) | | | |
| Extruded bonding | 25-100 | 35-80 | 50-70 |
| layer (60) | | | |
| Barrier layer (30) | 2-60 | 2-40 | 5-25 |
| Additional layer on | 5-100 | 5-60 | 10-40 |
| the outside (50) | | | |
| Total layer thickness | 100-250 | 120-200 | 140-180 |
| of the laminate | | | |

16. A multilayered, especially thin, laminate having at least one oriented film and at least one barrier layer, there being arranged between two, especially sealable, outer films an extrudate having a barrier layer material, the extrudate being in the form of a barrier-containing extruded bonding layer, which is bounded by two outer plies which have each been laminated directly onto the respective outer film in a one-shot process, at least one outer film being an oriented outer film.

17. A multilayered, especially thin, laminate having two oriented sealable outer films and at least one barrier layer, there having been arranged between the outer films in a one-shot process an extrudate having a barrier layer material, the extrudate being in the form of a barrier-containing extruded bonding layer, which is bounded by two outer plies which have each been laminated directly onto the respective outer film.

18. A multilayered laminate according to claim 16, wherein the oriented film is a monoaxially or biaxially stretched film.

19. A multilayered laminate according to claim 16, wherein the barrier layer is arranged between two outer plies of the barrier-containing extruded bonding layer.

20. A multilayered laminate according to claim 16, wherein an adhesion-promoting layer is arranged between at least one outer ply and the barrier layer.

21. A multilayered laminate according to claim 16, wherein the barrier-containing extruded bonding layer is constructed symmetrically in respect of the barrier layer.

22. A multilayered laminate according to claim 16, wherein the outer ply is multilayered, especially two-layered.

23. Multilayered A multilayered laminate according to claim 16, wherein an additional layer has been applied to the outside of at least one outer film.

24. A multilayered laminate according to claim 16, wherein the oriented outer film is a co-extruded film having at least one sealable skin-layer layer.

25. A multilayered laminate according to claim 16, wherein the layers of the laminate have been produced from one or more of the following materials:

| Layer | Materials | |
|---|---|---|
| Oriented | Polypropylene (PP); polyester, especially polyethylene | |
| outer film | terephthalate (PET); polyamide (PA) and mixtures of the | |
| (40), | mentioned substances | |
| sealable, | | |
| especially | | |
| co-extruded | | |
| Non- | Polyolefins, especially polyethylene (PE), polypropylene (PP); | |
| oriented | modified olefins; co-polymers; terpolymers, ionomers; polyamide | |
| outer film | (PA) or polyacrylonitrile (PAN) and mixtures of the mentioned | |
| (40) | substances | |
| Barrier- | Outer ply | Polyolefins, especially polyethylene (PE), poly- |
| containing | (10) | propylene (PP); modified olefins; copolymers; |
| extruded | | terpolymers; ionomers; ethylene/acrylic acid |
| bonding layer (60) | | copolymer (EAA); ethylene-methacrylic acid (EMA); |
| | | maleic anhydride (MA) and mixtures of the |
| | | mentioned substances |
| | Adhesion- | Ethylene/acrylic acid copolymer (EAA); ethylene- |
| | promoting | methacrylic acid (EMA); maleic anhydride (MA); |
| | layer (20) | modified olefins, especially ionomers; copolymers; |
| | | terpolymers and mixtures of the mentioned |
| | | substances |
| | Barrier | Ethylene vinyl alcohol copolymer (EVOH); |
| | layer (30) | amorphous and/or aromatic and/or partially aromatic |
| | | polyamide (PA); polyacrylonitrile (PAN); |
| | | polyethylene terephthalate (PET) and mixtures of the |
| | | mentioned substances |
| | |
|---|---|
| Additional | Polyolefins, especially polyethylene (PE), polypropylene (PP); |
| layer on the | modified olefins; copolymers; terpolymers; ionomers; |
| outside (50) | ethylene/acrylic acid copolymer (EAA); ethylene-methacrylic acid |
| | (EMA); amorphous and/or aromatic and/or partially aromatic |
| | polyamide (PA); polyacrylonitrile (PAN); and mixtures of the |
| | mentioned substances |

26. A multilayered laminate according to claim 16, wherein the layers of the laminate have been produced in a thickness as follows:

| | | | Especially |
|---|---|---|---|
| | | Preferred layer | preferred layer |
| | Layer thickness | thickness | thickness |
| Layer | [μm] | [μm] | [μm] |
| Oriented outer film | 10-70 | 20-60 | 30-50 |
| (40) | | | |
| Non-oriented outer | 20-150 | 40-90 | 50-80 |
| film (40) | | | |
| Extruded bonding | 25-100 | 35-80 | 50-70 |
| layer (60) | | | |
| Barrier layer (30) | 2-60 | 2-40 | 5-25 |
| Additional layer on | 5-100 | 5-60 | 10-40 |
| the outside (50) | | | |
| Total layer thickness | 100-250 | 120-200 | 140-180 |
| of the laminate | | | |
